(19) United States
(12) Patent Application Publication
(10) Pub. No.: US 2009/0301701 A1
(43) Pub. Date: Dec. 10, 2009

(54) Use of a Heat Exchanger Tube

(76) Inventors: Andreas Beutler, Weissenhorn (DE); Johann Gschaider, Nersingen (DE); Robert Kloeckler, Illertissen (DE); Hans-Achim Kuhn, Illertissen (DE); Eberhard Lepin, Illertissen (DE); Christoph Walther, Weissenhorn (DE); Rolf Wamsler, Oberelchingen (DE); Martin Straub, Illertissen (DE); Wolfgang Zeiler, Bellenberg (DE)

Correspondence Address: FLYNN THIEL BOUTELL & TANIS, P.C., 2026 RAMBLING ROAD, KALAMAZOO, MI, 49008-1631, US

(21) Appl. No.: 12/225,514

(22) PCT Filed: Mar. 17, 2007
(86) PCT No.: PCT/EP2007/002379

§ 371 Date: Jun. 19, 2009

(30) Foreign Application Priority Data
Mar. 23, 2006 (DE) 10-2006-013-384.6

(51) Int. Cl. F28F 21/08; C09K 5/04; F25B 1/00

(52) U.S. Cl. 165/180; 62/114; 62/115; 165/181

(57) ABSTRACT

The invention relates to the use of a heat exchanger tube, comprising a copper alloy, which contains the alloying elements [in percent by weight] 0.05-3% Fe, 0.01-0.15% P, and optionally 0.05-0.2% Zn, 0.02-0.05% Sn and residual Cu as well as unavoidable impurities, as a gas-cooler, condenser or evaporator tube of a refrigerator or heat pump operating with CO2.

The present invention relates to the use of a heat exchanger tube comprising a copper alloy.

The replacement of the chlorine-containing safety refrigerants (CFC), owing to their harmful effect on the ozone layer, by chlorine-free safety refrigerants (FHC) was soon followed by discussion about their high greenhouse potential. For this reason, the natural refrigerants, especially CO₂, were increasingly considered.

CO₂, as a natural refrigerant which does not contribute to the destruction of the ozone layer and is neutral with respect to the direct contribution to the greenhouse effect, is an ecologically interesting alternative to the FHC refrigerants predominantly used today in Europe, which is economical depending on application and general conditions.

Thus, applications in cascade operation with NH₃ in which CO₂ evaporators and condensers are used in the subcritical mode, but also transcritical CO₂ refrigeration processes and CO₂ heat pumps in which the evaporator operates below the critical point of CO₂ and the gas cooler corresponding to the condenser operates above the critical point of CO₂, are known in refrigeration technology.

Particularly in the latter case of the gas cooler, the operating range of the refrigerant CO₂ is at pressures up to 130 bar and hence well above the pressures up to 35 bar customary in the case of CFC and FHC safety refrigerants. However, even for evaporators, permissible pressures up to 50 bar are required depending on the application, particularly if hot gas thawing is intended.

These pressure requirements can be realized only with difficulty with copper pipes comprising Cu-DHP, which are usually used in heat exchangers operated with CFC and FHC safety refrigerants, since very large tube wall thicknesses have to be used, with correspondingly adverse effects on the processibility, in particular the widening and bending, the weight of the heat exchanger and the apparatus costs. Instead, it is current practice to use tubes of hot-galvanized steel or stainless steel, with which said pressures can be relatively easily managed.

However, the steel or stainless steel tubes used to date also have substantial disadvantages compared with copper with respect to the processibility, the efficiency and the costs, so that it is the object of the invention to find alternative solutions which permit the use of copper alloys in the case of small tube wall thicknesses even at high pressures.

The invention is reproduced by the features of claim 1. The further related claims relate to advantageous developments and further developments of the invention.

The invention includes the technical teaching to use a heat exchanger tube consisting of a copper alloy which contains the alloy elements [in % by weight]

### 0.05-3% of Fe,

### 0.01-0.15% of P,

and optionally

### 0.05-0.2% of Zn,

### 0.02-0.05% of Sn

and Cu as the remainder and unavoidable impurities as a gas cooler, condenser or evaporator tube of a refrigerator or heat pump operating with CO₂.

The invention starts from the consideration that a heat exchanger tube having a substantially smooth or structured surface on the inside for use in the gas cooler, condenser or evaporator of a refrigerator or a heat pump operating with CO₂ is employed. In this context, the term substantially smooth on the inside also includes surfaces formed by weld seams. The operating medium CO₂ flows on the inside of the heat exchanger tubes and, depending on the temperature conditions of the special application, has a pressure which is substantially higher than the pressures known for CFC and FHC safety refrigerants and sets high requirements with regard to the pressure resistance of the tubes used.

In general, stainless steels and steels have preferably been used to date in corresponding applications since the copper tubes comprising Cu-DHP, otherwise customary in refrigeration/air conditioning technology, have had considerable cost disadvantages to date owing to the pressure and the required large wall thicknesses.

The particular advantage is that substantial material savings are thus permitted by the Cu alloys according to the invention which have a higher strength and permit small wall thicknesses even at high pressures, and weight and cost advantages are achieved thereby. In addition, these Cu alloys have excellent properties in processing, in particular widening, bending and soldering.

In a preferred development of the invention, the external tube diameter may be in the range of 3-16 mm. In this context, the ratio of the wall thickness to the external tube diameter can advantageously be chosen in the range from 0.025 to 0.08. This gives rise to tube wall thicknesses which are in a similar size range to copper tubes customarily used today for FHC safety refrigerants and comprising Cu-DHP, and hence promise very good properties with regard to the further processibility.

In a preferred further development, the tube material may have a yield strength R_{p0.2} above 160 N/mm². It is furthermore preferable if the tube material has a tensile strength Rₘ above 300 N/mm². For example for a tube having an external diameter of 9.52 mm and an operating pressure of 130 bar, this results in necessary tube wall thicknesses of not more than 0.55 mm and hence a material saving of more than 40% compared with tubes comprising Cu-DHP.

Preferably, the heat exchanger tube can be formed from a strip material and have a weld seam. Weld seams which extend in the axial direction or are spiral in form are also suitable. In particular, high-frequency welding methods are suitable as a possible joining method for tube production. As particular advantages over other joining methods, this results firstly in realizable high manufacturing speeds and secondly in a joint state which, after a customarily following annealing process, has no losses of strength compared with the material not influenced by the joining process.

Alternatively, the heat exchanger tube may be seamless. Seamless tubes and welded tubes can, however, be regarded as being equivalent in the use according to the invention.

Further advantages arise if the surface of the inside of the tube is structured. This makes it possible to increase the heat transfer coefficient and hence the heat transfer capacity.

1. A heat exchanger tube consisting of a copper alloy which contains the alloy elements [in % by weight]
0.05-3% of Fe,
0.01-0.15% of P,
and optionally
0.05-0.2% of Zn,
0.02-0.05% of Sn
and Cu as the remainder and unavoidable impurities used as a gas cooler, condenser or evaporator tube of a refrigerator or heat pump operating with CO₂.

2. The heat exchanger tube as claimed in claim 1, characterized in that the external tube diameter is in the range of 3-16 mm.

3. The heat exchanger tube as claimed in claim 2, characterized in that the ratio of the wall thickness to the external tube diameter is in the range from 0.025 to 0.08.

4. The heat exchanger tube as claimed in claim 1, characterized in that the tube material has a yield strength R_{p0.2} above 160 N/mm².

5. The heat exchanger tube as claimed in claim 1, characterized in that the tube material has a tensile strength Rₘ above 300 N/mm².

6. The heat exchanger tube as claimed in claim 1, characterized in that the heat exchanger tube is formed from a strip material and has a weld seam.

7. The heat exchanger tube as claimed in claim 1, characterized in that the heat exchanger tube is seamless.

8. The heat exchanger tube as claimed in claim 1, characterized in that the surface of the inside of the tube is structured.
